(19) United States
(12) Patent Application Publication
(10) Pub. No.: US 2025/0073131 A1
(43) Pub. Date: Mar. 6, 2025

(54) PACIFIER DEVICE

(71) Applicant: Elijah Bolling, Esko, MN (US)

(72) Inventor: Elijah Bolling, Esko, MN (US)

(21) Appl. No.: 18/654,670

(22) Filed: May 3, 2024

Related U.S. Application Data
(60) Provisional application No. 63/579,185, filed on Aug. 28, 2023.

(51) Int. Cl. A61J 17/00

(52) U.S. Cl. CPC A61J 17/001; A61J 17/1011; A61J 17/1012

(57) ABSTRACT

A pacifier device that includes location finding features in addition to common features of a pacifier for children. The pacifier device includes a beep unit that can generate an intense unit. A control unit can receive a command from a user device within a predefined distance from the pacifier device over a wireless network, and the control unit upon receiving the command, triggers the beep unit to emit an intense audio signal. The user device can be a smartphone and the user can follow the audio signal to find the misplaced pacifier device quickly and easily.

### CROSS-REFERENCE TO RELATED APPLICATIONS

This application claims priority from a U.S. Provisional Patent Appl. No. 63/579,185 filed on Aug. 28, 2023 which is incorporated herein by reference in its entirety.

### FIELD OF INVENTION

The present invention relates to a pacifier for children, and more particularly, the present invention relates to a pacifier with an inbuilt geolocating unit.

### BACKGROUND

Babies and their pacifiers share a special connection. Pacifiers can help to instantly calm and soothe infants and young children, and even the fussiest infants. Typically pacifiers help a child to satisfy the natural urge to suck. But when these tiny treasures go missing, it can lead to frustration and distress for both babies and their tired parents. Finding a lost pacifier can often become a challenge. For example, the pacifier may have fallen into a hidden spot, or gotten with other items. Moreover, the child may drop the pacifier or place the pacifier in a less obvious place. The struggle to find a lost pacifier can turn a peaceful moment into a frantic search. Moreover, a spare pacifier may not be available to the caregiver when the pacifier could not be found. Thus, losing the pacifiers is quite common in households and a need is appreciated for a device to help locate a misplaced pacifier.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a pacifier device for children that can be electronically located.

Another object of the present invention is that a misplaced pacifier device can be easily and quickly located.

Still, it is another object of the present invention that the pacifier device is safe for children.

Yet another object of the present invention is that the pacifier device can be located by a smartphone.

In one aspect, disclosed is a pacifier device that represents an innovative solution to a common parenting challenge, offering convenience and peace of mind to caregivers of young children. The disclosed pacifier device helps a caregiver easily and quickly locate a misplaced pacifier.

In one aspect, disclosed is a pacifier device utilized for pacifying children, the pacifier device comprises a beep unit configured to generate an intense sound signal; and a control unit configured to receive a command from a user device and in response to the command, trigger the beep unit to emit the sound signal. The pacifier device further comprises a light indicator configured to emit a light signal, wherein the control unit is also configured to trigger the light indicator upon receiving the command. The pacifier device further comprises a GPS circuitry configured to determine current geographic coordinates of the pacifier device, wherein the control unit is configured to transmit the current geographic coordinates to the user device upon receiving the command. The pacifier device further comprises a network circuitry for an external network, wherein the command and the current geographic coordinates are transmitted over the external network. The external network is Bluetooth® or Wi-Fi.

In one aspect, disclosed is a method for finding a pacifier, the method comprises incorporating a location finding unit into a pacifier unit. The pacifier unit comprises a teat, a shield, a base, and a handle. The location finding unit comprises a beep unit configured to generate an intense sound signal, and a control unit configured to receive a command from a user device and in response to the command, trigger the beep unit to emit the sound signal. The method further comprises steps of sending, by the user device, over a wireless network, the command to the location finding unit; and triggering the beep unit, by the control unit, upon receiving the command.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a block diagram of the pacifier device showing its architecture and environment, according to an exemplary embodiment of the present invention.

FIG. 2 is a perspective view of the pacifier device, according to an exemplary embodiment of the present invention.

FIG. 3 is another perspective view of the pacifier device, according to an exemplary embodiment of the present invention.

FIG. 4 is another perspective view in which a charging dock is shown coupled to a base of the device, according to an exemplary embodiment of the present invention.

FIG. 5 shows the charging indicators on the charging dock, according to an exemplary embodiment of the present invention.

### DETAILED DESCRIPTION

Subject matter will now be described more fully hereinafter concerning the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The described invention pertains to a pacifier device and a method for finding a misplaced pacifier device. The pacifier device includes most of the features of traditional pacifiers utilized for pacifying children. Additionally, the pacifier device incorporates a geolocating unit that helps find a misplaced pacifier device using various user devices, such as a smartphone, smartwatch, tablet computer, and the like.

This present invention intends to address the common issue of pacifiers being lost or misplaced by providing a means to easily locate them using a smartphone. By integrating a geolocating unit into the pacifier device, caregivers can use their smartphones or other compatible devices to pinpoint the location of the pacifier device, thereby saving time and reducing frustration.

The method for locating the pacifier device likely involves establishing a connection between the pacifier device and the user's device, possibly through Bluetooth® or another wireless communication protocol. Once connected, the user can activate the geolocating feature on their user device, prompting the pacifier device to emit a signal and/or provide its location information. This location information can be displayed on the user's device, guiding them to the misplaced pacifier. The user can in most cases follow the sound emitted by the pacifier device to locate the same.

In certain implementations of the disclosed pacifier device, the user device can send a signal to the pacifier device, triggering it to emit a loud audio signal, such as a beep. The user can follow the sound of the beep and/or the blinking light from the pacifier device to find the pacifier device quickly and easily. Additionally, the user device can display the location of the pacifier device overlaid on the layout of the home, further assisting the user in finding it.

In certain implementations of the disclosed pacifier device, the pacifier device is designed to address situations where it may be misplaced by either the caregiver or the child. For instance, the child may drop the pacifier anywhere, or a parent may place it somewhere and later forget its location. In both scenarios, the disclosed pacifier device can be easily located using the user device.

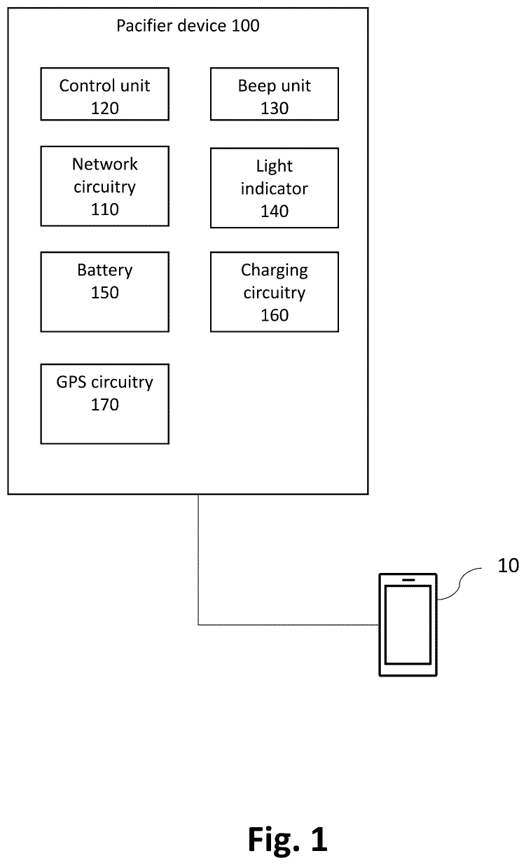

Referring to FIG. 1, which depicts a block diagram showing the architecture and environment of the disclosed pacifier device 100, it likely illustrates how the components of the pacifier device interact with each other and with the user device to enable the location-finding functionality. The pacifier device may include a network circuitry 110, a control unit 120, a beep unit 130, a light indicator 140, a battery 150, a charging circuitry 160, and a GPS circuitry. This architecture facilitates the seamless operation of the pacifier device in conjunction with the user's device, enhancing its usability and effectiveness in locating the pacifier.

The pacifier device described includes network circuitry for connecting to a user device 10, such as a smartphone, smartwatch, laptop, tablet, or similar computing devices. This connection allows for one-way and/or two-way communication between the disclosed pacifier device and the user device. Communication networks such as Bluetooth®, Wi-Fi, cellular networks, or any other suitable wireless network can be utilized. The network circuitry is designed to consume minimal power, ensuring a long battery life for the pacifier device.

The control unit can receive a command/instruction from the user device and trigger the beep unit and/or light indicator accordingly. The beep unit emits a loud sound, customizable in type, intensity, and duration, while the light indicator assists in locating the pacifier device, especially in dark environments. Both the beep and light indicator can automatically turn off after a predefined duration, managed by suitable timing circuitry, which can be a part of the control unit.

Additionally, the pacifier device may incorporate GPS circuitry to determine its geographical coordinates. These coordinates can be transmitted by the control unit to the user device, aiding in locating the pacifier device.

The disclosed pacifier device further includes a teat (nipple), shield, base, and ring (handle). The teat and shield follow conventional pacifier designs, while the base houses electronic components such as the control unit, beep unit, light indicators, and GPS circuitry. The ring serves as a handle, as well as a means of entertainment for the child. The base may also contain a battery for powering the different electronic components. The battery may be disposable or rechargeable. In the case of rechargeable batteries, suitable charging circuitry can also be incorporated into the pacifier device. The charging circuitry includes a charging port located in the housing of the base, preferably exposed underside of the base. A charging dock can be used to charge the pacifier device's battery.

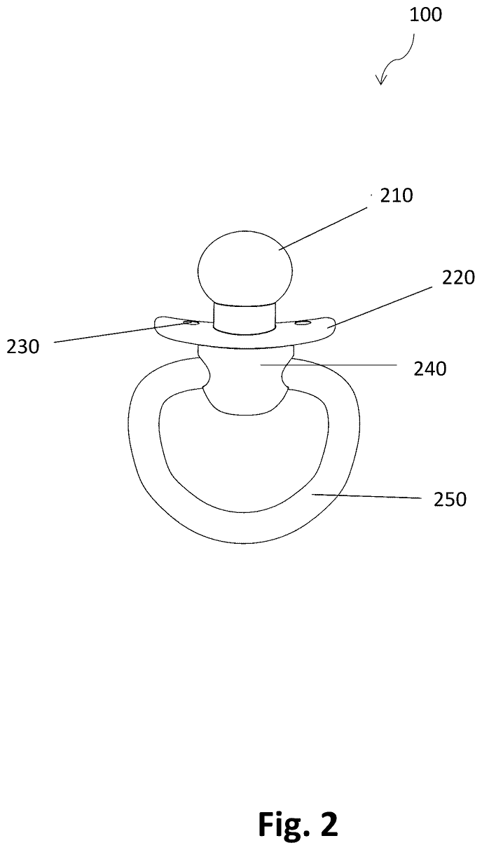

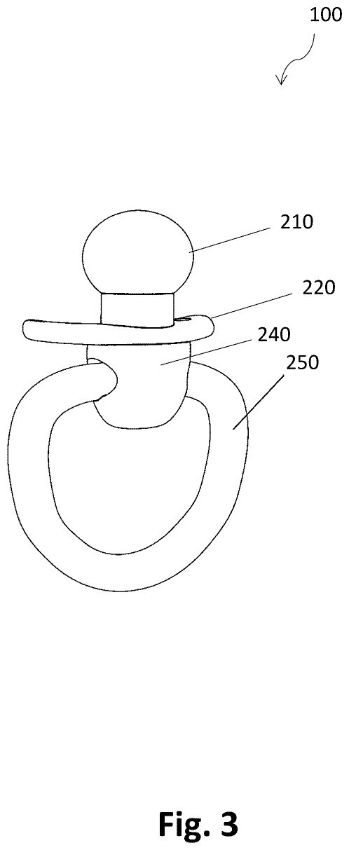

FIGS. 2 and 3 depict perspectives of the implemented pacifier device, showcasing its components. FIG. 2 shows the teat 210, also known as a nipple that can be sucked by a child for satisfying the urge. The structure and function of the teat is well known for use in pacifiers. The teat can be similar to any conventional pacifier and any variations in the type and shape of the teat are within the scope of the present invention.

The shield 220 is also common in conventional pacifier designs utilized to prevent choking hazards. The shield can include one or more ventilation holes 230 to prevent the choking hazard. The number, shape, and size of these ventilation holes can be varied without departing from the scope of the present invention. A base 240 is shown below the shield to which the ring 250 is rotatable mounted. The ring may act as a handle for the pacifier device. The child can hold the ring and rotate the same for fun. The base can house the battery, the control unit, the beep unit, the light indicators, and the GPS circuitry. A charging port (not shown) can be exposed on the underside of the base, which is used for charging the battery. The electronic components within the base, including the charging port can be protected from exposure to water, moisture, and air. For example, using waterproof housing and the ports can be sealable.

The different electronic components can be encased within the base and/or the ring of the pacifier device. Preferably, the components including the control unit, the beeper, light indicator, and GPS can be housed within the base of the pacifier device. However, any variation or a different location in the pacifier device is within the scope of the present invention.

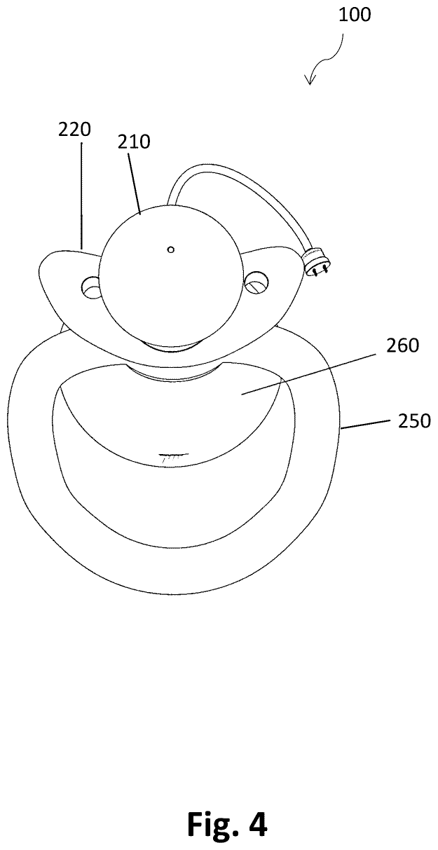

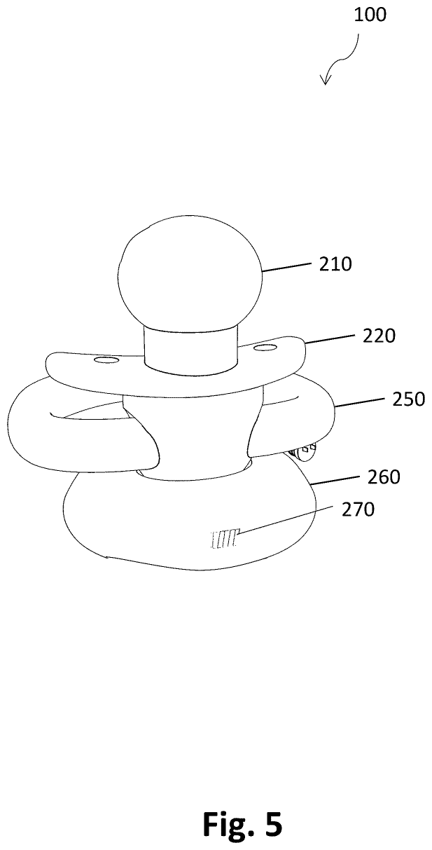

A charging dock 260 is shown in FIGS. 4 and 5, the charging dock can couple to the charging port in the base. The dock can be connected to a power supply and can charge the battery of the pacifier device. The charging indicator 270 can also be provided on the dock as shown in FIG. 5.

In certain implementations of the pacifier device, an interface can be presented on the user device. The interface allows the user to send the command or instruction to the pacifier device. Moreover, the interface can show the current locations of the user device and the pacifier device on a screen, taking into consideration the orientation of phone in a direction. The locations are shown with directions for the user to reach the pacifier device. The interface may use the features of compass in the user device for determining the directions. In absence of such a functionality, the increasing and decreasing distance between the user device and the pacifier device can be used to determine the direction in which the user should move to reach the pacifier device.

The interface can be provided as application software that can be installed on the user device. The application software can be developed for Android™, iOS, and any other known operating platform for mobile devices. The application software can be made available through a distribution service provider, for example, Google Play™ operated and developed by Google, and the app store by Apple. In addition to the application software, a website-based interface can also be provided through the world-wide-web. The application software can also be provided for the desktop environment, such as Windows™, Linux, and macOS.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A pacifier device utilized for pacifying children; the pacifier device comprises:
a beep unit configured to generate an intense sound signal; and
a control unit configured to receive a command from a user device and in response to the command, trigger the beep unit to emit the sound signal.

2. The pacifier device of claim 1, wherein the pacifier device further comprises:
a light indicator configured to emit a light signal, wherein the control unit is also configured to trigger the light indicator upon receiving the command.

3. The pacifier device of claim 2, wherein the pacifier device further comprises a GPS circuitry configured to determine current geographic coordinates of the pacifier device, wherein the control unit is configured to transmit the current geographic coordinates to the user device upon receiving the command.

4. The pacifier device of claim 3, wherein pacifier device further comprises a network circuitry for an external network, wherein the command and the current geographic coordinates are transmitted over the external network.

5. The pacifier device of claim 4, wherein the external network is Bluetooth® or Wi-Fi.

6. A method for finding a pacifier, the method comprises:
incorporating a location finding unit into a pacifier unit, the pacifier unit comprises a teat, a shield, a base, and a handle, wherein the location finding unit comprises:
a beep unit configured to generate an intense sound signal, and
a control unit configured to receive a command from a user device and in response to the command, trigger the beep unit to emit the sound signal;
sending, by the user device, over a wireless network, the command to the location finding unit; and
triggering the beep unit, by the control unit, upon receiving the command.
